(19) United States
(12) Patent Application Publication
(10) Pub. No.: US 2025/0393025 A1
(43) Pub. Date: Dec. 25, 2025

(54) COMMUNICATION METHOD AND INFORMATION PROCESSING METHOD

(71) Applicant: TOYOTA JIDOSHA KABUSHIKI KAISHA, Toyota-shi (JP)

(72) Inventors: Jing MA, Tokyo (JP); Lei ZHONG, Tokyo (JP)

(73) Assignee: TOYOTA JIDOSHA KABUSHIKI KAISHA, Toyota-shi (JP)

(21) Appl. No.: 19/239,256

(22) Filed: Jun. 16, 2025

(30) Foreign Application Priority Data
Jun. 19, 2024 (JP) 2024-099003

(51) Int. Cl. H04W 64/00; H04W 12/06

(52) U.S. Cl. CPC H04W 64/006; H04W 12/06

(57) ABSTRACT

A communication method comprises: receiving, by a first access point that is capable of communicating with user equipment that moves, mobility information about movement of the user equipment, the mobility information being received from the user equipment in a first frequency band; and performing, by the first access point, communication with the user equipment in a second frequency band and in a communicable period during which communication with the user equipment is enabled, the communicable period being determined based on the mobility information.

### CROSS REFERENCE TO THE RELATED APPLICATION

This application claims the benefit of Japanese Patent Application No. 2024-099003, filed on Jun. 19, 2024, which is hereby incorporated by reference herein in its entirety.

### BACKGROUND

### Technical Field

The present disclosure relates to wireless communication.

### Description of the Related Art

There is a technique for enabling a user terminal to roam among a plurality of access points in a wireless LAN environment (for example, IEEE802.11r, [online], May 14, 2024, IEEE802, [searched on May 31, 2024], Internet <URL: https://www.ieee802.org/11/Reports/tgr_update.htm>).

### SUMMARY

An object of the present disclosure is to achieve fast roaming in wireless communication.

The present disclosure in its one aspect provides a communication method comprising: receiving, by a first access point that is capable of communicating with user equipment that moves, mobility information about movement of the user equipment, the mobility information being received from the user equipment in a first frequency band; and performing, by the first access point, communication with the user equipment in a second frequency band and in a communicable period during which communication with the user equipment is enabled, the communicable period being determined based on the mobility information.

The present disclosure in its another aspect provides a communication method performed by a first access point and a second access point that are capable of communicating with user equipment that moves, the communication method comprising: receiving, by the first access point, mobility information about movement of the user equipment, the mobility information being received from the user equipment in a first frequency band; sharing, by the first access point, the mobility information with the second access point; and performing, by the second access point, communication with the user equipment in a second frequency band and in a communicable period during which communication with the user equipment is enabled, the communicable period being determined based on the mobility information.

The present disclosure in its another aspect provides an information processing method performed by an information processing apparatus that is capable of communicating with a first access point and a second access point, the information processing method comprising: acquiring mobility information about movement of user equipment received by the first access point; and transmitting information for determining, based on the acquired mobility information, a communicable period during which communication with the user equipment is enabled, to the first access point and the second access point.

Furthermore, as another mode, an apparatus for performing the method described above, a program for causing a computer to perform the method described above, or a computer-readable storage medium storing the program in a non-transitory manner can be cited.

According to the present disclosure, fast roaming can be achieved in wireless communication.

### BRIEF DESCRIPTION OF THE DRAWINGS

FIG. 1 is a schematic diagram describing a communication system according to an embodiment;

FIG. 2 is a hardware configuration diagram of an onboard apparatus according to the embodiment;

FIG. 3 is a hardware configuration diagram of a roadside apparatus according to the embodiment;

FIG. 4 is a hardware configuration diagram of a control apparatus according to the embodiment;

FIG. 5 is a software configuration diagram of the onboard apparatus according to the embodiment;

FIG. 6 is a software configuration diagram of the roadside apparatus according to the embodiment;

FIG. 7 is a software configuration diagram of the control apparatus according to the embodiment;

FIG. 8 is a flowchart describing phases performed by respective apparatuses;

FIG. 9 is a sequence diagram illustrating a flow of data in a detection phase;

FIG. 10 is a sequence diagram illustrating a flow of data in a transmission/reception phase; and

FIG. 11 is a sequence diagram illustrating a flow of data in a detection phase in a second embodiment.

### DESCRIPTION OF THE EMBODIMENTS

In relation to a wireless LAN environment such as Wi-Fi (registered trademark), there is a system for enabling a user terminal to roam among a plurality of access points. In the system, a result of authentication of the user terminal is shared by a plurality of access points, for example.

Accordingly, even in a case where the user terminal moves and a connection destination access point changes, an authentication phase can be omitted and re-connection can be performed in a short time.

There is a movement to apply a communication method according to Wi-Fi to a mobile body that moves at a high speed. For example, mobile communication can be achieved at a low cost by disposing a plurality of access points along an arterial road and enabling roaming.

However, output of a wireless signal from a Wi-Fi access point is weak compared to that of a base station for cellular communication, and also, coverage is small. That is, a communicable time per access point for a mobile body is short. For example, in the case where a communication range of an access point has a radius of 100 m and a vehicle is moving at 72 km per hour, the communicable time is 10 seconds. In such a case, a sufficient communication time cannot be secured and throughput cannot be increased by a regular Wi-Fi roaming procedure of “make an attempt to connect to another access point in a case where electric field strength falls below a specified value”, for example.

A communication method according to the present disclosure solves such a problem.

A communication method according to an aspect of the present disclosure includes receiving, by a first access point that is capable of communicating with user equipment that moves, mobility information about movement of the user equipment, the mobility information being received from the user equipment in a first frequency band, and performing, by the first access point, communication with the user equipment in a second frequency band and in a communicable period during which communication with the user equipment is enabled, the communicable period being determined based on the mobility information.

The first access point is one of a plurality of access points that are capable of communicating with the user equipment. The plurality of access points may be a plurality of roadside apparatuses that are installed at predetermined intervals along a road, for example.

The first access point receives the mobility information from the user equipment before data communication is started. The mobility information is information about movement of the user equipment, and is typically information including a current position, a moving speed, a moving direction, a scheduled route or the like of the user equipment. In the case where the user equipment is mounted on a vehicle, the mobility information may be acquired by an apparatus that controls autonomous traveling of the vehicle or a car navigation apparatus. A future movement of the user equipment may be estimated by referring to such mobility information. The mobility information may be included in a connection request transmitted from the user equipment, for example.

The first access point receives the mobility information in the first frequency band. The first frequency band is a sub frequency band different from a frequency band (second frequency band) in which primary data communication is performed between the access point and the user equipment. Typically, the first frequency band is a frequency band lower than the second frequency band. For example, in the case where the second frequency band is a gigahertz band, the first frequency band may be a megahertz band. Additionally, a boundary between the first frequency band and the second frequency band may be set as appropriate within a range of 1 GHz to 5 GHz. For example, in the case where the second frequency band is a frequency band equal to or more than 5 GHz, the first frequency band may be a frequency band less than 5 GHZ.

According to such a configuration, a period during which communication can be performed between the first access point and the user equipment can be determined based on the mobility information. That is, the first access point can grasp beforehand when the user equipment is to reach and leave a communicable range of the subject apparatus.

With conventional Wi-Fi roaming, the user equipment has to determine “the access point with which communication is to be performed”, based on a change over time in the electric field strength, for example. By contrast, with the method according to the present disclosure, a period during which communication with the user equipment can be performed is grasped by the access point, and thus, fast roaming can be performed.

Additionally, the first access point may share the received mobility information with the second access point.

For example, the first access point that is installed along a road may transmit the received mobility information to a plurality of other access points (second access points) installed along the road.

According to such a configuration, a plurality of access points capable of communicating with the user equipment can each grasp the communicable period for the user equipment.

Additionally, an operation of sharing the mobility information may be performed by a center server (information processing apparatus) that manages the first and second access points.

For example, the information processing apparatus may acquire the mobility information from the first access point, and transmit the acquired mobility information to the second access point.

Additionally, a process of calculating the communicable period based on the mobility information may be performed by the center server (information processing apparatus).

For example, the information processing apparatus that manages the first and second access points may acquire the mobility information from the first access point, calculate the communicable period in relation to each of the first and second access points based on the mobility information, and notify each of the first and second access points of the calculated communicable period.

Furthermore, the mobility information may include at least one of position information and a moving speed of the user equipment.

Furthermore, the mobility information may further include at least one of a moving direction and a scheduled route of the user equipment.

The mobility information is used by each access point to determine a communicable period for the subject apparatus and the user equipment. Accordingly, the mobility information desirably includes information for determining a change over time in a position of the user equipment.

Additionally, in the case where the mobility information includes a plurality of information pieces, the information pieces do not have to be transmitted by a same protocol. For example, the information pieces may be transmitted by different protocols corresponding to different network layers.

Furthermore, the first frequency band may be a frequency band having a wider communicable range than the second frequency band.

The first frequency band is a frequency band for sharing the mobility information prior to data communication. Accordingly, the first frequency band is desirably a frequency band having a wider communicable range than the second frequency band. This allows the mobility information to be more swiftly acquired and shared. For example, the first frequency band may be a frequency band less than 5 GHZ, and the second frequency band may be a frequency band equal to or more than 5 GHz.

Furthermore, the first access point may further receive, in the first frequency band, authentication information for authenticating the user equipment, and may transmit the authentication information to an information processing apparatus for authenticating the user equipment.

Furthermore, the first access point may receive, from the information processing apparatus, authentication result information indicating a result of authentication performed based on the authentication information.

The information processing apparatus may be an apparatus including a function of authenticating the user equipment. In this case, the information processing apparatus may provide a result of authentication of the user equipment to a plurality of access points including the first access point. This allows each access point to omit an authentication phase, and fast roaming can be performed among a plurality of access points.

Additionally, the information processing apparatus does not have to include the function of authenticating the user equipment. In this case, the information processing apparatus may perform authentication of the user equipment by using an external authentication apparatus. Also in this case, the authentication result information is transmitted from the information processing apparatus to the first access point.

Hereinafter, specific embodiments of the present disclosure will be described with reference to the drawings. A hardware configuration, a module configuration, a functional configuration and the like described in each embodiment are not intended to limit the technical scope of the disclosure thereto unless stated otherwise.

### First Embodiment

### [Outline of System]

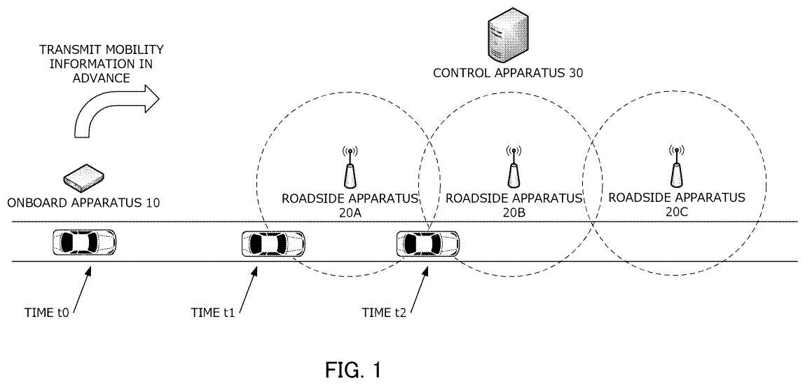

An outline of a communication system according to a first embodiment will be given with reference to FIG. 1. The communication system according to the present embodiment includes a plurality of roadside apparatuses 20 installed along a road, and a control apparatus 30 that controls the plurality of roadside apparatuses 20 in an overall manner. The roadside apparatus 20 is an example of “access point”.

Additionally, FIG. 1 illustrates roadside apparatuses 20A, 20B, 20C, and in the case where it is not necessary to distinguish among the three, the term “roadside apparatus(es) 20” will be used.

The communication system according to the present embodiment is a system that performs wireless communication according to a communication procedure defined in IEEE802.11. The plurality of roadside apparatuses 20 include a common group address for identifying a group, and a local address unique to each apparatus. The group may correspond to a mobility domain according to IEEE802.11.

The plurality of roadside apparatuses 20 may belong to a common basic service set (BSS). An onboard apparatus 10 as user equipment may access one of the roadside apparatuses 20 by using a common identifier such as the group address, a BSSID or the like, and receive authentication. An authentication result is shared among the plurality of roadside apparatuses 20, and the onboard apparatus 10 can thus change a connection destination roadside apparatus 20 without performing an authentication procedure again.

The roadside apparatuses 20A, 20B, 20C each have a range (for example, a radius of about 100 meters; indicated by a dotted line in FIG. 1) where data communication with the onboard apparatus 10 can be performed.

The onboard apparatus 10 can connect to and communicate with one of the roadside apparatuses 20 while moving. Furthermore, the roadside apparatus 20 as the connection destination can be switched during communication.

With conventional Wi-Fi roaming, the onboard apparatus 10 determines that switching of the roadside apparatus as a connection destination (that is, roaming) is necessary, based on electric field strength of radio waves received from the roadside apparatus, for example. However, in the case where a vehicle where the onboard apparatus 10 is mounted is moving fast, there is often not enough time to measure the electric field strength or the like.

Accordingly, in the present embodiment, the onboard apparatus 10 notifies the communication system side in advance of information (mobility information) about movement of the subject vehicle, and the mobility information is shared among the plurality of roadside apparatuses 20. Accordingly, the plurality of roadside apparatuses 20 can each determine a period during which the onboard apparatus 10 is present in a communicable range of the subject apparatus. That is, the communication system can grasp a timing of switching of the roadside apparatus 20 as the connection destination without the vehicle having to measure the electric field strength or the like, and fast roaming can be achieved.

Furthermore, with the communication system according to the present embodiment, each roadside apparatus 20 is capable of communicating with the onboard apparatus 10 using two frequency bands, namely, a first frequency band and a second frequency band.

The second frequency band is a frequency band used to perform primary data communication, and is typically a frequency band equal to or more than 5 GHZ, such as 5 GHz or 60 GHz. The frequency band is characteristic in that fast data communication can be performed, but the communicable range is relatively narrow, being several tens of meters to about a hundred meters.

The first frequency band is a frequency band used to perform secondary data communication, and is typically a frequency band in a sub-5 GHz band, such as 2.4 GHz. The sub-5 GHz band is characteristic in that, although inferior to a frequency band equal to or more than 5 GHz (such as a 60 GHz band) in terms of speed of data communication, the communicable range is several times (for example, about several hundreds of meters) that of such a frequency band.

In the example in FIG. 1, dotted lines indicate the communicable ranges of the second frequency band. The communicable range of the first frequency band is wider than the ranges indicated by the dotted lines.

In the present embodiment, the onboard apparatus 10 includes a function of performing primary data communication with the roadside apparatus 20 in the second frequency band, and a function of transmitting the mobility information to the roadside apparatus 20 in the first frequency band. Because the communicable range of the first frequency band is wider than that of the second frequency band, the onboard apparatus 10 is able to transmit the mobility information to the communication system before primary data communication is started. The plurality of roadside apparatuses 20 included in the communication system can thus grasp in advance a time when data communication with the onboard apparatus 10 in the second frequency band becomes possible, and a time when the data communication is to be ended. For example, in the example in FIG. 1, the roadside apparatus 20A can grasp, at a timing of a time to, that data communication in the second frequency band can be performed from a time t1 to a time t2.

### [Hardware Configuration]

Next, a hardware configuration of each apparatus constituting the system will be described.

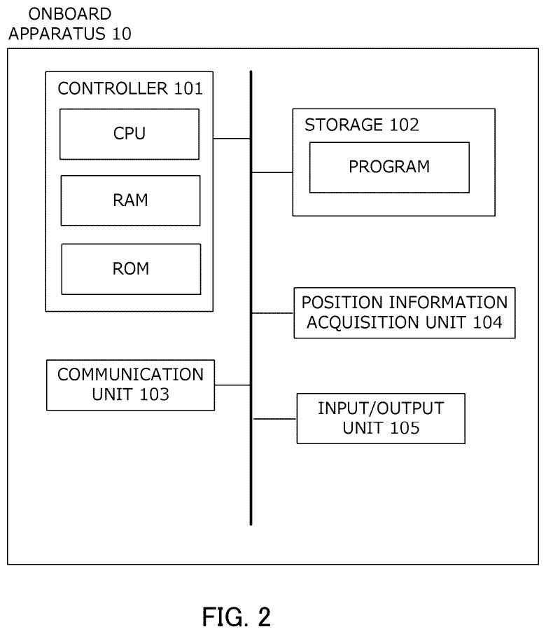

FIG. 2 is a diagram schematically illustrating an example of the hardware configuration of the onboard apparatus 10 that can be mounted on a vehicle.

The onboard apparatus 10 can be configured as a computer including a processor (CPU, GPU, etc.), a main memory (RAM, ROM, etc.), and an auxiliary memory (EPROM, hard disk drive, removable medium, etc.). The auxiliary memory stores an operating system (OS), various programs, various tables and the like, and each function (software module) matching a predetermined object as described later can be implemented through execution of a program that is stored therein. However, one or some or all of functions may alternatively be implemented as a hardware module by a hardware circuit such as an ASIC or an FPGA, for example.

The onboard apparatus 10 includes a controller 101, a storage 102, a communication unit 103, a position information acquisition unit 104, and an input/output unit 105.

The controller 101 is an arithmetic unit that implements various functions of the onboard apparatus 10 by executing predetermined programs. For example, the controller 101 may be implemented by a hardware processor such as a CPU. Furthermore, the controller 101 may include a RAM, a ROM (Read Only Memory), a cache memory, and the like.

The storage 102 is means for storing information, and is a storage medium such as a RAM, a magnetic disk, or a flash memory. The storage 102 stores programs to be executed by the controller 101, data to be used by the programs, and the like.

The communication unit 103 is a wireless communication interface for transmitting/receiving wireless signals. For example, the communication unit 103 is capable of transmitting/receiving wireless signals according to a standard such as wireless LAN. Furthermore, the communication unit 103 is capable of transmitting/receiving the wireless signals using two different frequency bands. In the present embodiment, the communication unit 103 is capable of transmitting/receiving wireless signals in two frequency bands, i.e., a frequency band less than 5 GHz (first frequency band), and a frequency band equal to or more than 5 GHZ (second frequency band).

The position information acquisition unit 104 acquires position information of a vehicle 1. The position information acquisition unit 104 includes a GPS antenna and a positioning module for measuring the position information. The GPS antenna is an antenna that receives a positioning signal transmitted from a positioning satellite (also referred to as a GNSS satellite). The positioning module is a module that calculates the position information based on the signal received by the GPS antenna. Additionally, the position information acquisition unit 104 may determine a traveling direction of the vehicle 1 based on a change in the position information.

The input/output unit 105 is a unit that receives input from an onboard person in the vehicle, and that presents information to the onboard person. More specifically, the input/output unit 105 includes a touch panel and control means thereof, and a liquid crystal display and control means thereof. In the present embodiment, the touch panel and the liquid crystal display are one touch panel display.

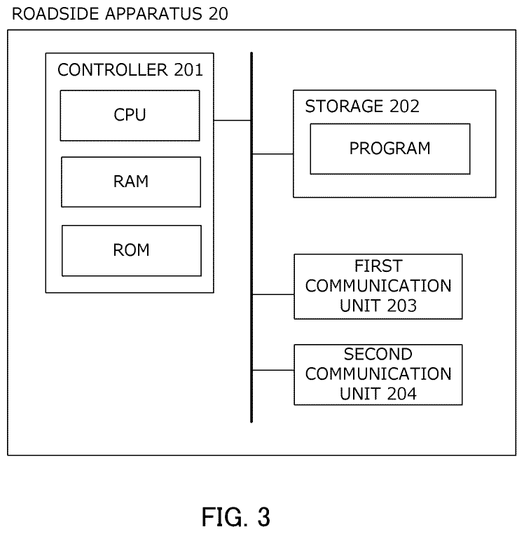

Next, the hardware configuration of the roadside apparatus 20 will be described. FIG. 3 is a diagram schematically illustrating an example of the hardware configuration of the roadside apparatus 20.

Like the onboard apparatus 10, the roadside apparatus 20 can be configured as a computer including a processor (CPU, GPU, etc.), a main memory (RAM, ROM, etc.), and an auxiliary memory (EPROM, hard disk drive, removable medium, etc.).

The roadside apparatus 20 includes a controller 201, a storage 202, a first communication unit 203, and a second communication unit 204.

The controller 201 is an arithmetic unit that implements various functions of the roadside apparatus 20 by executing predetermined programs. For example, the controller 201 may be implemented by a hardware processor such as a CPU. Furthermore, the controller 201 may include a RAM, a ROM (Read Only Memory), a cache memory, and the like.

The storage 202 is means for storing information, and is a storage medium such as a RAM, a magnetic disk, or a flash memory. The storage 202 stores programs to be executed by the controller 201, data to be used by the programs, and the like.

The first communication unit 203 is a wireless communication interface for transmitting/receiving wireless signals to/from the onboard apparatus 10. For example, the first communication unit 203 is capable of transmitting/receiving wireless signals according to a standard such as wireless LAN. Like the communication unit 103, the first communication unit 203 is capable of transmitting/receiving the wireless signals using two different frequency bands.

The second communication unit 204 is a communication interface for communicating with the control apparatus 30. The second communication unit 204 may be a wireless communication interface, or may be a wired communication interface.

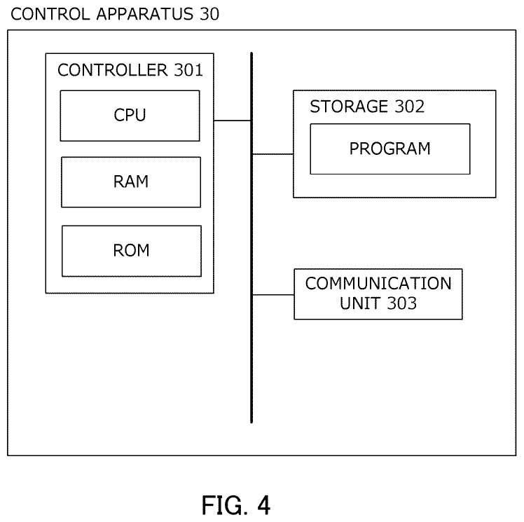

Next, the hardware configuration of the control apparatus 30 will be described. FIG. 4 is a diagram schematically illustrating an example of the hardware configuration of the control apparatus 30.

Like the roadside apparatus 20, the control apparatus 30 can be configured as a computer including a processor (CPU, GPU, etc.), a main memory (RAM, ROM, etc.), and an auxiliary memory (EPROM, hard disk drive, removable medium, etc.).

The control apparatus 30 includes a controller 301, a storage 302, and a communication unit 303.

The controller 301 is an arithmetic unit that implements various functions of the control apparatus 30 by executing predetermined programs. For example, the controller 301 may be implemented by a hardware processor such as a CPU. Furthermore, the controller 301 may include a RAM, a ROM (Read Only Memory), a cache memory, and the like.

The storage 302 is means for storing information, and is a storage medium such as a RAM, a magnetic disk, or a flash memory. The storage 302 stores programs to be executed by the controller 301, data to be used by the programs, and the like.

The communication unit 303 is a communication interface for communicating with the roadside apparatus 20. The communication unit 303 may be a wireless communication interface, or may be a wired communication interface.

Additionally, in the present embodiment, the control apparatus 30 is assumed to be an independent computer, but the control apparatus 30 may instead be virtually implemented as a logical entity. For example, a process to be performed by the control apparatus 30 described in the present specification may be performed in a distributed manner by a plurality of roadside apparatuses 20. In this case, the plurality of roadside apparatuses 20 serve the role of the control apparatus 30 in the present embodiment. In this case, the controller 301 may also serve as the controller 201, the storage 302 as the storage 202, and the communication unit 303 as the second communication unit 204. Furthermore, in the case where there is an apparatus that connects the plurality of roadside apparatuses 20 to each other, a virtual control apparatus 30 may be implemented on the apparatus.

### [Software Configuration]

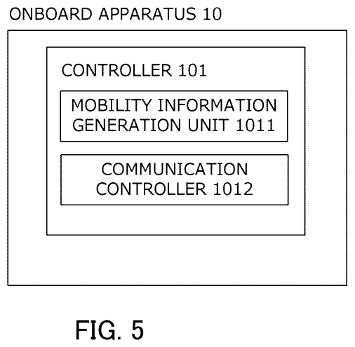

Next, a software configuration of each apparatus constituting the system will be described. FIG. 5 is a diagram schematically illustrating the software configuration of the onboard apparatus 10 according to the present embodiment. The configuration of the hardware of the onboard apparatus 10 is as illustrated in FIG. 2.

In the present embodiment, the controller 101 of the onboard apparatus 10 includes two software modules, namely, a mobility information generation unit 1011 and a communication controller 1012. Each software module may be implemented through execution of a program stored in the storage 102 by the controller 101 (CPU or the like). Additionally, information processing that is performed by the software module is synonymous with information processing that is performed by the controller 101 (CPU or the like).

The mobility information generation unit 1011 generates the mobility information that is to be transmitted to the communication system. In the present embodiment, the mobility information includes at least one of a current position, a moving speed, a traveling direction, and a scheduled route of the vehicle where the onboard apparatus 10 is mounted. The mobility information generation unit 1011 may acquire such information pieces from a computer (such as an ECU) that controls traveling of the subject vehicle, a navigation apparatus, or a user terminal associated with an onboard person. Furthermore, the mobility information generation unit 1011 may acquire such information pieces based on a change over time in position information that is acquired by the position information acquisition unit 104. The mobility information is transmitted to the roadside apparatus 20 in the communication system via the communication controller 1012 described later.

The communication controller 1012 performs two types of processes, namely, (1) a process of requesting the communication system for start of communication, and performing handshake, and (2) a process of establishing connection to one of a plurality of roadside apparatuses 20, and performing transmission/reception of data (including roaming).

Firstly, the communication controller 1012 performs a step of detecting presence of the roadside apparatus 20 included in the communication system, and requesting the communication system for connection. In the present step, the communication controller 1012 receives a beacon signal transmitted from the roadside apparatus 20, and in response, performs a procedure for authentication by using authentication information that is stored in advance.

For example, the authentication information is an identifier for uniquely identifying the onboard apparatus 10, a key that is used at the time of connecting the onboard apparatus 10 to the communication system, or an electronic certificate. Additionally, authentication information that is stored in the onboard apparatus 10 and authentication information that is transmitted to the roadside apparatus 20 may be different from each other. For example, in the case where a private key is stored in the onboard apparatus 10, a hash or the like generated based on the private key may be transmitted to the roadside apparatus 20.

Handshake is thus performed between the onboard apparatus 10 and the communication system.

Secondly, the communication controller 1012 establishes connection between the onboard apparatus 10 and the roadside apparatus 20, performs transmission/reception of data, and performs switching (roaming) of a connection destination using other roadside apparatuses 20 as necessary.

A specific control method will be described later.

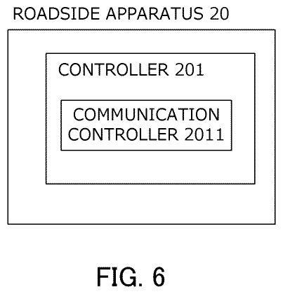

Next, the software configuration of the roadside apparatus 20 will be described. FIG. 6 is a diagram schematically illustrating the software configuration of the roadside apparatus 20 according to the present embodiment. The configuration of the hardware of the roadside apparatus 20 is as illustrated in FIG. 3.

In the present embodiment, the controller 201 of the roadside apparatus 20 includes a software module of a communication controller 2011. The software module may be implemented through execution of a program stored in the storage 202 by the controller 201 (CPU or the like). Additionally, information processing that is performed by the software module is synonymous with information processing that is performed by the controller 201 (CPU or the like).

The communication controller 2011 communicates with the onboard apparatus 10 based on information that is acquired from the control apparatus 30 described later. More specifically, the communication controller 2011 performs the following processes.

(1) A process of receiving a request for starting communication from the onboard apparatus 10, and causing the control apparatus 30 to perform authentication.

The communication controller 2011 receives, from the onboard apparatus 10, data (hereinafter “start request”) for requesting the communication system for handshake, and transfers the start request to the control apparatus 30. Authentication of the onboard apparatus 10 is thereby performed by the control apparatus 30. Additionally, in the case where the control apparatus 30 does not include an authentication function, the control apparatus 30 may perform authentication of the onboard apparatus 10 by using an external authentication apparatus.

(2) A process of receiving an authentication result from the control apparatus 30.

The communication controller 2011 receives, from the control apparatus 30, a result of authenticating the onboard apparatus 10. The authentication result is transmitted from the control apparatus 30 to every roadside apparatus 20 included in the communication system. In the case where authentication of the onboard apparatus 10 by the control apparatus 30 succeeds, each roadside apparatus 20 is able to confirm authenticity of the onboard apparatus 10.

(3) A process of receiving the mobility information from the onboard apparatus 10, and transferring the same to the control apparatus 30.

The communication controller 2011 receives the mobility information from the onboard apparatus 10 that transmitted the start request mentioned above, and transfers the mobility information to the control apparatus 30.

The control apparatus 30 thus causes the mobility information to be shared among a plurality of roadside apparatuses 20.

(4) A process of receiving the mobility information from the control apparatus 30.

In the case where the subject apparatus (roadside apparatus 20) does not directly receive the start request from the onboard apparatus 10 (that is, in the case where the start request is received by another roadside apparatus 20 included in the communication system), the communication controller 2011 receives the mobility information that is transmitted by the control apparatus 30.

(5) A process of communicating with the onboard apparatus 10 based on the acquired mobility information.

The communication controller 2011 calculates a communicable period for the onboard apparatus 10 based on the acquired mobility information, and establishes communication with the onboard apparatus 10 in the period.

The mobility information may be information that is directly received from the onboard apparatus 10, or may be information that is transmitted from the control apparatus 30 (that is, the mobility information that is shared by the entire communication system).

A specific control method will be described later.

Next, the software configuration of the control apparatus 30 will be described.

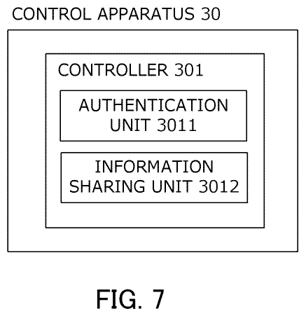

FIG. 7 is a diagram schematically illustrating the software configuration of the control apparatus 30 according to the present embodiment.

The configuration of the hardware of the control apparatus 30 is as illustrated in FIG. 4.

In the present embodiment, the controller 301 of the control apparatus 30 includes two software modules, namely, an authentication unit 3011 and an information sharing unit 3012.

Each software module may be implemented through execution of a program stored in the storage 302 by the controller 301 (CPU or the like).

Additionally, information processing that is performed by the software module is synonymous with information processing that is performed by the controller 301 (CPU or the like).

The authentication unit 3011 performs authentication of the onboard apparatus 10 based on authentication information that is acquired from the onboard apparatus 10 via the roadside apparatus 20. The authentication unit 3011 may perform authentication based on a pre-shared key (PSK), for example. In this case, the authentication information is a key that is generated based on a passphrase. The authentication unit 3011 may perform IEEE802.1x authentication, for example. In this case, the authentication information is a combination of a user name and a password, or an electronic certificate.

Additionally, a case is conceivable where the control apparatus 30 does not include the authentication function. In this case, the authentication unit 3011 may relay the acquired authentication information to an external authentication apparatus, and may cause the authentication apparatus to perform authentication of the onboard apparatus 10.

In the case where mobility information corresponding to the onboard apparatus 10 is transmitted from the roadside apparatus 20 included in the communication system, the information sharing unit 3012 transmits the mobility information to other roadside apparatuses 20 (having a same group address, for example) included in the same communication system.

Moreover, the information sharing unit 3012 transmits a result of authentication performed by the authentication unit 3011 to other roadside apparatuses 20 belonging to the same communication system. Accordingly, the mobility information and the authentication result associated with an onboard apparatus 10 that is newly connected to the communication system are shared.

### [Process Flowchart]

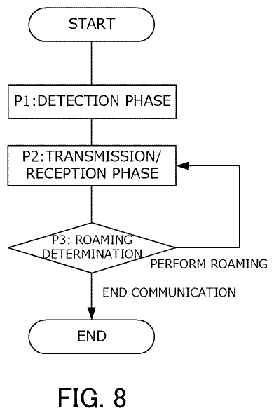

Next, a flow of processes of communication will be described. FIG. 8 is a diagram describing phases of processing performed by the onboard apparatus 10, the roadside apparatus 20, and the control apparatus 30 according to the present embodiment. In the present embodiment, communication is performed in three phases.

A first phase (P1) is a phase in which the onboard apparatus 10 recognizes presence of the roadside apparatus 20, and performs handshake with the communication system (detection phase). In the detection phase, the onboard apparatus 10 receives a beacon signal transmitted from the roadside apparatus 20, and in response, transmits data (start request) for requesting the communication system for handshake.

Transmission/reception of data in the present phase is performed in the first frequency band.

The roadside apparatus 20 receiving the start request performs authentication of the onboard apparatus 10 via the control apparatus 30, and receives the mobility information from the onboard apparatus 10. The authentication result and the mobility information are shared, via the control apparatus 30, with other roadside apparatuses 20 included in the communication system.

Each of the plurality of roadside apparatuses 20 recognizes that the onboard apparatus 10 is already authenticated by the system based on the acquired authentication result. Furthermore, each of the plurality of roadside apparatuses 20 calculates a period during which communication with the onboard apparatus 10 can be performed, based on the acquired mobility information.

A next phase (P2) is a phase in which the onboard apparatus 10 and the roadside apparatus 20 perform transmission/reception of data. As described above, in the detection phase, each roadside apparatus 20 is able to grasp the period during which communication with the onboard apparatus 10 can be performed.

In the present phase, first, the onboard apparatus 10 broadcasts a request (hereinafter “transmission request”) for transmission of data. Next, a roadside apparatus 20 that is capable of communicating with the onboard apparatus 10 (i.e., that is in the communicable period) responds to the request, and performs transmission/reception of data. When the communicable period elapses, the roadside apparatus 20 transmits a notification indicating end of communication to the onboard apparatus 10.

When the communicable period elapses, transition to a phase (P3) of determining availability or unavailability of roaming takes place. In the present phase, the onboard apparatus 10 broadcasts the transmission request again. Among the roadside apparatuses 20 receiving the transmission request, a roadside apparatus 20 that is capable of taking over communication (roaming) (that is, a roadside apparatus 20 newly reaching the communicable period in relation to the onboard apparatus 10) responds to the request, and takes over communication. In the case where there is no roadside apparatus 20 that enables roaming, communication is ended.

Next, processes performed by each apparatus in each phase described above will be specifically described.

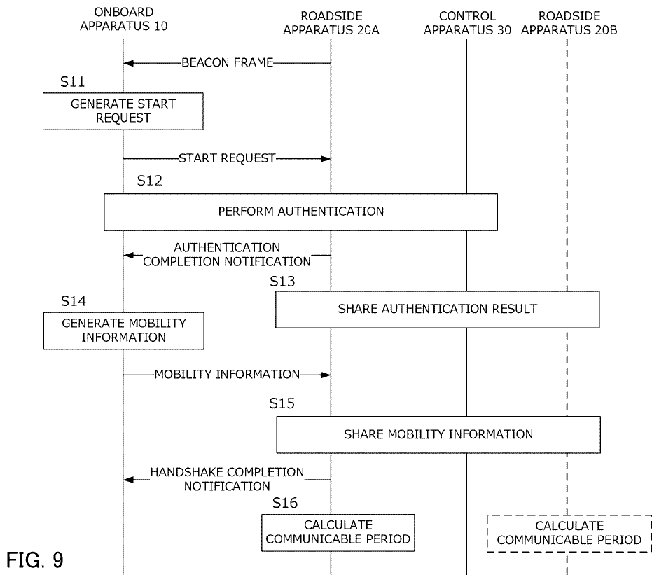

FIG. 9 is a sequence diagram of data that is transmitted/received among the onboard apparatus 10, the roadside apparatus 20, and the control apparatus 30 in the detection phase. Additionally, in the present example, an apparatus with which the onboard apparatus 10 performs communication first is the roadside apparatus 20A, and an apparatus that takes over the communication is the roadside apparatus 20B.

First, the onboard apparatus 10 (communication controller 1012) receives a beacon frame. The beacon frame is data that is broadcast in the first frequency band by the roadside apparatus 20 to announce its presence.

When the onboard apparatus 10 receives the beacon frame from the roadside apparatus 20A, the onboard apparatus 10 generates the start request in step S11. The start request is data for requesting the communication system for handshake. The start request that is generated is transmitted to the roadside apparatus 20A by a wireless signal in the first frequency band.

When the start request is received by the roadside apparatus 20A, the roadside apparatus 20A (communication controller 2011) transitions to a step (step S12) of performing authentication of the onboard apparatus 10. In step S12, information for performing authentication is exchanged between the onboard apparatus 10 and the control apparatus 30. The roadside apparatus 20A relays such information pieces to the control apparatus 30. The control apparatus 30 (authentication unit 3011) authenticates the onboard apparatus 10 based on the authentication information received from the onboard apparatus 10. For example, authentication may be based on pre-shared key (PSK) or IEEE802.1x authentication. Authentication may be performed by the control apparatus 30, or the control apparatus 30 may make a request to an external authentication apparatus and the authentication apparatus may perform authentication.

When authentication is correctly completed, a notification to the effect (authentication completion notification) is transmitted to the onboard apparatus 10 via the roadside apparatus 20A.

Next, in step S13, the control apparatus 30 performs a process of sharing the result of authenticating the onboard apparatus 10 with a plurality of roadside apparatuses 20 included in the communication system. In the present step, the control apparatus 30 (information sharing unit 3012) transmits the result of authentication performed in step S12 to the roadside apparatus 20 belonging to the same communication system (for example, the roadside apparatus 20 having a same group address as the roadside apparatus 20A). Accordingly, the authentication result of the onboard apparatus 10 is shared by all the roadside apparatuses 20 that enable roaming. Accordingly, the roadside apparatuses 20 do not have to individually perform authentication of the onboard apparatus 10.

The onboard apparatus 10 (mobility information generation unit 1011) receiving the authentication completion notification generates the mobility information (step S14). In the present embodiment, the mobility information includes a current position, a moving speed, and a moving direction of the vehicle where the subject apparatus is mounted. The mobility information generation unit 1011 may acquire such information pieces from components of the vehicle 1 (such as a vehicle speed sensor, a gyro sensor, an engine ECU, a body ECU, and the like). The mobility information that is generated is transmitted to the roadside apparatus 20A.

Next, in step S15, the roadside apparatus 20A performs a process of sharing the mobility information received from the onboard apparatus 10 with a plurality of roadside apparatuses 20 included in the communication system. In the present step, the roadside apparatus 20A transmits the mobility information received from the onboard apparatus 10 to the control apparatus 30, and the control apparatus 30 (information sharing unit 3012) transmits the mobility information to the roadside apparatuses 20 belonging to the same communication system (i.e., having a same ESS-ID). The mobility information transmitted from the onboard apparatus 10 is thereby shared by all the roadside apparatuses 20 that enable roaming.

When the present step is complete, a notification indicating completion of handshake is transmitted from the roadside apparatus 20A to the onboard apparatus 10.

In step S16, each roadside apparatus 20 (communication controller 2011) that acquired the mobility information calculates a respective period during which communication with the onboard apparatus 10 is possible. For example, the roadside apparatus 20 calculates a period during which communication between the subject apparatus and the onboard apparatus 10 is possible, based on the current position of the onboard apparatus 10, the speed, the moving direction, a position of the subject apparatus, a communicable range of the subject apparatus, and the like. A result of the calculation is held by each roadside apparatus 20 until end of communication with the onboard apparatus 10.

Data exchange in the processes described above is performed in the first frequency band. The first frequency band is a frequency band lower than a frequency band (second frequency band) for performing primary data communication. Generally, when a frequency of a radio wave becomes lower, the communicable range is increased due to diffraction attenuation properties. Accordingly, the communication system can complete authentication of the onboard apparatus 10 and share the mobility information at a timing before entry of the onboard apparatus 10 into the communicable range based on the second frequency band.

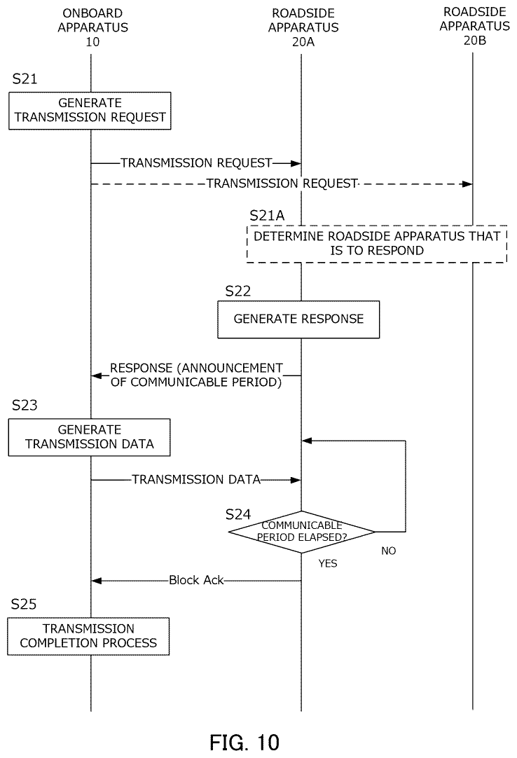

FIG. 10 is a sequence diagram of data that is transmitted/received among the onboard apparatus 10, the roadside apparatus 20, and the control apparatus 30 in the transmission/reception phase (and the roaming determination phase). The illustrated processes are repeatedly performed in a period after completion of handshake between the onboard apparatus 10 and the communication system and until communication is completed. Additionally, in the present example, a case is described where data is transmitted from the onboard apparatus 10 to the communication system.

First, the onboard apparatus 10 generates a transmission request (step S21). The transmission request is data that is broadcast by the onboard apparatus 10 after completion of handshake between the onboard apparatus 10 and the communication system to look for a roadside apparatus 20 to which connection can be performed. The transmission request is transmitted in the second frequency band.

The transmission request is received by the roadside apparatus 20 that is closest to the onboard apparatus 10 (in this case, the roadside apparatus 20A). Additionally, step S21A is not essential, and will be described later.

The roadside apparatus 20A that received the transmission request generates a response for starting communication (step S22). In the present embodiment, the response includes following information pieces.
Identifier of the subject apparatus (roadside apparatus)
Position information of the subject apparatus
Mobility information held by the subject apparatus
Communicable period determined based on the mobility information

The communicable period may be expressed by clock time, for example. The onboard apparatus 10 can grasp a period during which the subject apparatus and the roadside apparatus 20A can communicate with each other, by referring to the response.

After receiving the response, the onboard apparatus 10 generates data (transmission data) to be transmitted to the communication system (step S23). The transmission data is transmitted from the onboard apparatus 10 (communication controller 1012) and is received by the roadside apparatus 20A (communication controller 2011) upon arrival of the communicable period indicated by the roadside apparatus 20A. The roadside apparatus 20A (communication controller 2011) may sequentially transfer received data to the control apparatus 30 or a gateway to an external network.

During reception of data, the roadside apparatus 20A periodically determines whether the communicable period has elapsed or not (step S24). In the case where the communicable period has not elapsed, the roadside apparatus 20A continues to receive data. In the case where the communicable period has elapsed, the roadside apparatus 20A completes reception of data, and transmits an acknowledgement (Block Ack) to the onboard apparatus 10.

The onboard apparatus 10 receiving the acknowledgement recognizes end of communication with the roadside apparatus 20A, and performs a process of ending data transmission (step S25). In the present step, the onboard apparatus 10 identifies a block for which data transmission is completed and a block that is not yet transmitted, for example.

In the case where the process in step S25 is complete and there is still data that is yet to be transmitted, the onboard apparatus 10 starts again the processes illustrated in FIG. 10. That is, the onboard apparatus 10 newly generates the transmission request, and broadcasts the same. In the case of the example in FIG. 1, when communication with the roadside apparatus 20A is ended, communication with the roadside apparatus 20B is enabled. In this case, the transmission request is received by the roadside apparatus 20B with which communication can be performed next, and the roadside apparatus 20B transmits the response to the onboard apparatus 10. In this manner, a plurality of roadside apparatuses 20 successively perform communication with the onboard apparatus 10.

As described above, the communication system according to the first embodiment receives the mobility information from the onboard apparatus 10 by using the first frequency band, and shares the mobility information with a plurality of roadside apparatuses 20. Furthermore, each of the plurality of roadside apparatuses 20 determines a period during which communication can be performed with the onboard apparatus 10, based on the mobility information. When a plurality of roadside apparatuses 20 calculate the communicable period in advance, fast roaming is enabled.

Additionally, in the example in FIG. 10, lapse of the communicable period is determined by the roadside apparatus 20 (step S24), but the determination may instead be performed by the onboard apparatus 10. In this case, the onboard apparatus 10 may notify the roadside apparatus 20 that the communicable period elapsed (or is about to elapse), and the roadside apparatus 20 may, in response, end reception of data, and return the acknowledgement.

### Modification of First Embodiment

Additionally, depending on a positional relationship between the vehicle and the roadside apparatuses 20, the transmission request is possibly received by a plurality of roadside apparatuses 20. For example, the transmission request is possibly received by both the roadside apparatus 20A and the roadside apparatus 20B. In this case, each may generate the response, and individually transmit the response to the onboard apparatus 10. Also in this case, the communicable period is different for each roadside apparatus 20, and the onboard apparatus 10 can thus successively communicate with each roadside apparatus 20. In the case where the communicable periods overlap each other, the onboard apparatus 10 may switch the roadside apparatus 20 as the connection destination at an appropriate timing.

Furthermore, by taking into account a case of simultaneous reception of the transmission request by a plurality of roadside apparatuses 20, a step of determining which roadside apparatus 20 is to respond to the onboard apparatus 10 (step S21A in FIG. 10) may be performed on the communication system side. In this step, each of the plurality of roadside apparatuses 20 receiving the transmission request may issue an inquiry to the control apparatus 30, and the control apparatus 30 may perform determination as to “is it OK to respond to the onboard apparatus 10?” and “in the case where the transmission request is received by a plurality of roadside apparatuses 20, which roadside apparatus 20 should respond? (or in what order should the roadside apparatuses 20 respond?)”, for example.

For example, the control apparatus 30 may determine the order in which a plurality of roadside apparatuses 20 should respond, based on the mobility information and arrangement positions of the plurality of roadside apparatuses 20, and may notify each roadside apparatus 20 of a result of the determination.

### Second Embodiment

In the first embodiment, the mobility information transmitted from the onboard apparatus 10 is shared by the roadside apparatuses 20, and each roadside apparatus 20 calculates the communicable period for the onboard apparatus 10 based on the mobility information. However, the process of calculating the communicable period may instead be performed by the control apparatus 30.

A second embodiment is an embodiment in which the control apparatus 30 calculates the communicable period for each roadside apparatus 20 based on the mobility information transmitted by the onboard apparatus 10, and notifies each roadside apparatus 20 of the calculated communicable period.

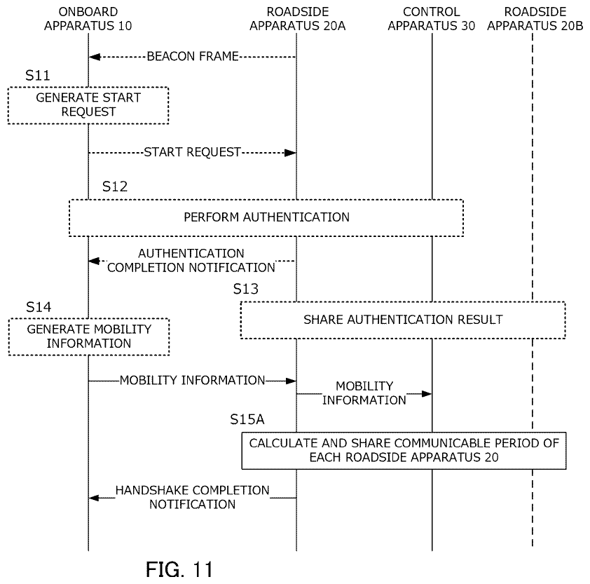

FIG. 11 is a sequence diagram of transmission/reception data in the second embodiment.

Additionally, the processes up to step S14 are the same as those in the first embodiment, and description thereof will be omitted.

In the present embodiment, the roadside apparatus 20A receiving the mobility information from the onboard apparatus 10 transfers the same to the control apparatus 30. Furthermore, the control apparatus 30 calculates the period during which each roadside apparatus 20 can communicate with the onboard apparatus 10, based on the received mobility information and installation positions of a plurality of roadside apparatuses 20, for example. A calculation result is transmitted to each roadside apparatus 20, and is temporarily stored in each roadside apparatus 20.

In this manner, the communicable period of each roadside apparatus 20 in relation to the onboard apparatus 10 may be determined by the control apparatus 30.

Additionally, in the present embodiment, an example is described where the control apparatus 30 separately notifies each roadside apparatus 20 of the communicable period, but the control apparatus 30 may instead generate an overall roaming plan based on the mobility information, and may share the same with all the roadside apparatuses 20. The roaming plan may include an order of connection of the onboard apparatus 10 to the roadside apparatuses 20, time (communication start time, communication end time), and the like.

In this case, the control apparatus 30 transmits the generated roaming plan to each roadside apparatus 20, and each roadside apparatus 20 may perform connection to the onboard apparatus 10 according to the plan. Furthermore, in this case, each roadside apparatus 20 may notify the control apparatus 30 of a status, at a timing of occurrence of roaming.

### Modifications

The embodiments described above are merely examples, and the present disclosure may be changed as appropriate within the scope of the disclosure.

For example, processes and means described in the present disclosure can be freely combined to the extent that no technical conflict exists.

Furthermore, the embodiments describe an example where the onboard apparatus 10 transmits (uploads) data to the communication system, but a direction of communication is not limited thereto. Data can be transmitted from the communication system to the onboard apparatus 10, and data can be freely transmitted/received during the communicable period.

Furthermore, in the embodiments, the first frequency band is a frequency band less than 5 GHZ, and the second frequency band is a frequency band equal to or more than 5 GHZ, but other frequency bands may also be used.

Furthermore, in the embodiments, the current position, the moving speed, the traveling direction, and the scheduled route of the vehicle are transmitted as the mobility information, but the information pieces do not necessarily have to be transmitted using a same protocol. For example, the current position and the moving speed may be transmitted using a first protocol, and the traveling direction and the scheduled route may be transmitted using a second protocol. Moreover, the first protocol and the second protocol do not have to correspond to a same network layer. For example, the first protocol may be a protocol in a physical layer or a MAC layer, and the second protocol may be a protocol in an application layer.

Moreover, the mobility information may include information (reception data and the like) obtained by communication with a GPS satellite.

Furthermore, the processes described as being performed by one device may be shared and executed by a plurality of devices. Alternatively, the processes described as being performed by different devices may be performed by a single device. In a computer system, the hardware configuration (server configuration) by which each function is realized can be flexibly changed.

The present disclosure can also be realized by supplying a computer program implementing the functions described in the above embodiments to a computer, and having one or more processors of the computer read and execute the program. Such a computer program may be provided to the computer by a non-transitory computer-readable storage medium connectable to the system bus of the computer, or may be provided to the computer via a network. Non-transitory computer-readable storage media include, for example, any type of disk, such as a magnetic disk (e.g., a floppy disk, a hard disk drive (HDD), etc.), an optical disk (e.g., a CD-ROM, a DVD disk, a Blu-ray disk, etc.), a read-only memory (ROM), a random-access memory (RAM), an EPROM, an EEPROM, a magnetic card, a flash memory, an optical card, or any type of medium suitable for storing electronic instructions.

What is claimed is:

1. A communication method comprising:
receiving, by a first access point that is capable of communicating with user equipment that moves, mobility information about movement of the user equipment, the mobility information being received from the user equipment in a first frequency band; and
performing, by the first access point, communication with the user equipment in a second frequency band and in a communicable period during which communication with the user equipment is enabled, the communicable period being determined based on the mobility information.

2. The communication method according to claim 1, wherein
the first access point shares the received mobility information with a second access point.

3. The communication method according to claim 1, wherein
the mobility information includes at least one of position information of the user equipment, and a moving speed of the user equipment.

4. The communication method according to claim 3, wherein
the mobility information further includes at least one of a moving direction of the user equipment, and a scheduled route of the user equipment.

5. The communication method according to claim 1, wherein
the first frequency band is a frequency band less than 5 GHZ, and
the second frequency band is a frequency band equal to or more than 5 GHZ.

6. The communication method according to claim 1, wherein
the first frequency band is a frequency band having a wider communicable range than the second frequency band.

7. The communication method according to claim 1, wherein
the first access point further receives, in the first frequency band, authentication information for authenticating the user equipment, and transmits the authentication information to an information processing apparatus for authenticating the user equipment.

8. The communication method according to claim 7, wherein
the first access point
receives, from the information processing apparatus, authentication result information indicating a result of authentication performed based on the authentication information.

9. A communication method performed by a first access point and a second access point that are capable of communicating with user equipment that moves, the communication method comprising:
receiving, by the first access point, mobility information about movement of the user equipment, the mobility information being received from the user equipment in a first frequency band;
sharing, by the first access point, the mobility information with the second access point; and
performing, by the second access point, communication with the user equipment in a second frequency band and in a communicable period during which communication with the user equipment is enabled, the communicable period being determined based on the mobility information.

10. The communication method according to claim 9, wherein
the second access point calculates the communicable period for a subject apparatus and the user equipment based on the mobility information.

11. The communication method according to claim 9, wherein
the first access point
transmits the mobility information to the second access point via a predetermined information processing apparatus.

12. The communication method according to claim 9, wherein
the mobility information includes at least one of position information of the user equipment, and a moving speed of the user equipment.

13. The communication method according to claim 12, wherein
the mobility information further includes at least one of a moving direction of the user equipment, and a scheduled route of the user equipment.

14. The communication method according to claim 9, wherein
the first frequency band is a frequency band less than 5 GHz, and
the second frequency band is a frequency band equal to or more than 5 GHZ.

15. The communication method according to claim 9, wherein
the first frequency band is a frequency band having a wider communicable range than the second frequency band.

16. The communication method according to claim 9, wherein
the first access point further receives, in the first frequency band, authentication information for authenticating the user equipment, and transmits the authentication information to an information processing apparatus for authenticating the user equipment.

17. The communication method according to claim 16, wherein
the first access point and the second access point receive, from the information processing apparatus, authentication result information indicating a result of authenticating the user equipment.

18. The communication method according to claim 17, wherein
upon arrival of the communicable period, the first access point and the second access point start communication with the user equipment based on the authentication result information, without performing authentication of the user equipment.

19. An information processing method performed by an information processing apparatus that is capable of communicating with a first access point and a second access point, the information processing method comprising:
acquiring mobility information about movement of user equipment received by the first access point; and
transmitting information for determining, based on the acquired mobility information, a communicable period during which communication with the user equipment is enabled, to the first access point and the second access point.

20. The information processing method according to claim 19, wherein
the communicable period is calculated for each of the first access point and the second access point based on the mobility information, and information about the calculated communicable period is transmitted to each of the first access point and the second access point.

21. The information processing method according to claim 19, wherein
authentication information for authenticating the user equipment is acquired from the first access point, and information indicating a result of authentication performed based on the authentication information is transmitted to each of the first access point and the second access point.
